(19) United States
(12) Patent Application Publication
(10) Pub. No.: US 2015/0099445 A1
(43) Pub. Date: Apr. 9, 2015

(54) Thermal Control of Vehicle Interiors

(71) Applicant: Gwendolyne Marie Ashburn, Belews Creek, NC (US)

(72) Inventor: Gwendolyne Marie Ashburn, Belews Creek, NC (US)

(21) Appl. No.: 14/048,831

(22) Filed: Oct. 8, 2013

(51) Int. Cl. B60H 1/24

(52) U.S. Cl. CPC B60H 1/24
USPC 454/152

(57) ABSTRACT

The present invention relates to systems, methods, and apparatus for controlling the interior of a vehicle at a desired temperature. In an embodiment, thermal control is attained for a car seat of an child, toddler, or infant. The systems and methods use a conduit system that allows air to be directed from air vents in vehicles to locations near or at passenger seats. The conduit system may connect to meshes or foams that provide additional cooling to passengers.

### FIELD OF THE INVENTION

The present invention relates to systems, methods, and apparatus for controlling the interior of a vehicle at a desired temperature. In an embodiment, thermal control is attained for a car seat of a child, toddler, or infant.

### BACKGROUND OF THE INVENTION

In the United States automobile accidents are the leading cause of death for children aged one to twelve years. The best way to protect children in vehicles is to secure them in car seats following appropriate age, height, and weight recommendations. Child seats are comprised of plurality of parts that have as their function the safety of the child. However, this plurality of parts also tends to constrict the child so that the child may become too hot (on hot days) or too cold (on days when the outside temperatures are cold). Thus, it would be desirable to be able to more rapidly cool and or heat areas in close proximity to infants, toddlers, and/or children in child seats.

During the summer, temperatures inside vehicles can become oppressive. As a matter of fact, more than 500 children have died in cars in the United States since 1998. There have been more than a thousand infants that have suffered heat stroke during this same time period. The temperature in passenger compartments can use substantially; especially, when the car is parked outside and the sun's heat radiation penetrates steadily through the windows. However, because of the closed environment and the properties of windows, the heat is unable to escape. In order to stabilize the interior temperatures of vehicles while the motor is running, many car models are equipped with air-conditioning systems. However, providing a sufficient cooling capacity, particularly in areas that are far removed from the vents where cool is air is released, requires a high energy expenditure. The effect of distance is exacerbated on sunny days when the outside temperature is quite elevated.

In contrast, during the winter, vehicle inhabitants are often confronted with very low temperatures in the vehicle's passenger compartment. After turning on the vehicle's heating system, it usually takes minutes before a significant temperature increase occurs. In areas that are far removed from the vents where warm air is released requires a high energy expenditure. In order to solve the problem, some car models may have heated seats. The energy necessary for running the seat heating system is provided by the car's battery. Due to the addition of new auxiliary systems for monitoring and controlling functions in the cars over the past years, the power supply needed for their operation has steadily increased. In order to prevent demands for further increases in the battery's capacity, smarter systems of heating must be developed and employed.

### BRIEF SUMMARY OF THE INVENTION

The present invention solves the above problems alluded to above for both heating and cooling. In an embodiment, the present invention solves problems related to the cooling and/or heating of infants, toddlers, and/or children in child restraint seats.

### BRIEF DESCRIPTION OF THE SEVERAL VIEWS OF THE DRAWING

FIG. 1 shows one embodiment of the connection means between the flexible tubing/hosing and the air vents and/or child safety seat.

FIG. 2 shows an embodiment of the connection means between the flexible tubing/hosing and the air vents and/or child safety seat.

FIG. 3 shows an embodiment of the connection means between the flexible tubing/hosing and the air vents and/or child safety seat.

FIG. 4 shows an embodiment of the connection means between the flexible tubing/hosing and the air vents and/or child safety seat.

FIG. 5 shows an embodiment of the child safety seat.

FIG. 6 shows an air vent that can be removed that allows a connection device to be inserted.

FIG. 7 shows a dashboard of a vehicle including an air vent wherein the flexible tubing of the present invention can be connected.

FIG. 8 shows a snap fit connection system of the present invention.

FIG. 9 shows an embodiment of the child seat in more detail.

FIG. 10 shows an embodiment of the pad.

### DETAILED DESCRIPTION OF THE INVENTION

In an embodiment of the invention, the present invention relates to a means of keeping a section of a vehicle at a temperature that is comfortable to the one or more passengers. In one embodiment, the present invention relates to a means of connecting the vents from the heater and/or the air conditioner of the vehicle to a vehicle's seat such as a child safety seat. In an embodiment, the means of connecting the vents to a vehicle's seat such as a child safety seat involves a means of attaching flexible tubing/hosing from the air vent to the back and/or side of a vehicle's seat and/or to the child safety seat. In one embodiment, the invention relates to a pad that can be placed on a vehicle's seat or inserted into a child safety seat that facilitates the passage of cool or hot air from the air vents of a vehicle to the pad.

The various embodiments of the invention will be described with reference to the drawings. It should be understood that although reference is made to the drawings, the drawings are not meant to limit the invention but rather to explain how the invention works. Modifications that do not depart from the spirit and scope of the invention are contemplated from the shown embodiments in the drawings.

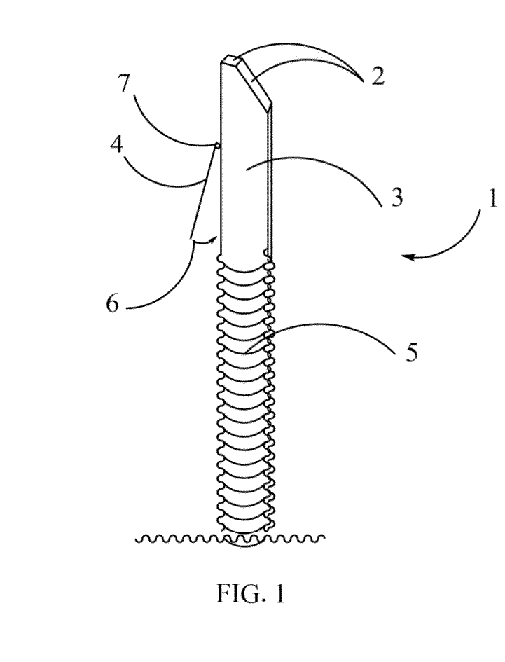

In one embodiment, the present invention relates to a means of connecting one or more air vents from a car to one or more seats in a vehicle using flexible tubing/hosing. In an embodiment, both the one or more air vents and the one or more seats have means of connecting the flexible tubing/hosing to them. FIGS. 1-4 show various embodiments with connection devices that allow the connection from the flexible tubing to the air vents and/or seats in the vehicle (including a child safety seat).

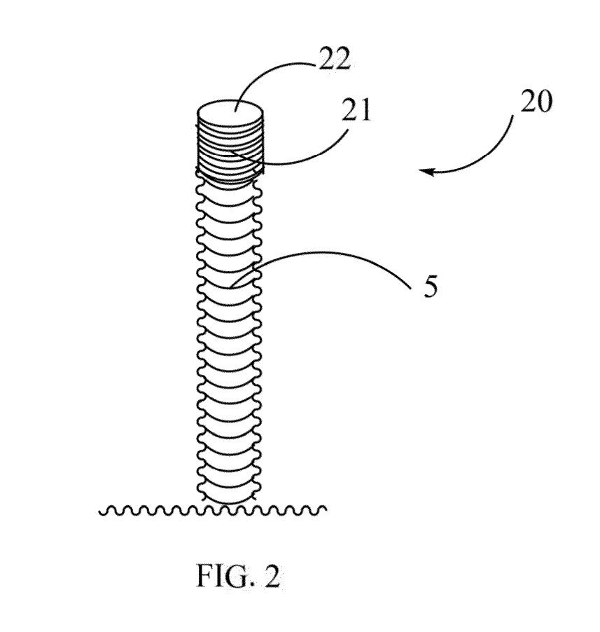

FIG. 1 shows the connection system 1 which includes a connection shaft 3, a lever device 4, and the flexible hosing/tubing 5. In one embodiment, the connection shaft 3 can be inserted into a vehicle air vent and/or to the side and/or back of a vehicle seat and/or a child safety seat. FIG. 1 shows the near end of the connection system 1, which shows only one connection means allowing connection of the flexible hosing/tubing 5 to a vehicle air vent but it should be understood that the far end of the flexible hosing/tubing 5 also contains a connection means that will connect the other side of the flexible hosing/tubing 5 to the side and/or back of a vehicle seat and/or a child safety seat. It should be understood that the connection shaft is only one means of interconnecting the flexible tubing/hosing 5 from the air vent to the passenger or child safety seat. Other means of connecting the flexible tubing/hosing 5 are shown in FIGS. 2-4. In FIG. 1, the lever device 4 will hold the connection shaft 3 in place. At the commencement of inserting the connection shaft 3 into the vehicle air vent, the lever device 4 contains a spring 7 that allows the lever device to be depressed 6 so that it is substantially flush with the connection shaft 3 allowing the entrance of the connection shaft 3 into the air vent. When the connection shaft 3 is inserted all of the way into the air vein (to a final distance), the lever device snaps back to the position shown in in FIG. 1 allowing the connection system 1 to remain in the vehicle air vent. Air passes by way of passageway 2 from the air vent through the connection shaft 3 through the flexible tubing/hosing 5 to the passenger and/or child safety seat.

Accordingly, in an embodiment, the air vent in which the connection shaft 3 is inserted is in a shape that is designed to accommodate the connection shaft 3 snuggly so that no air escapes when air travels from the first end of the flexible tubing/hosing 5 (adjacent the air vent) to the second end of the flexible tubing/hosing 5 (where the passenger or child, safety seat is positioned). The flexible tubing/hosing 5, in an embodiment, has no leaking air.

In an embodiment, the flexible tubing/hosing 5 may be insulated to better ensure that the temperature at the first end of the flexible tubing/hosing 5 is substantially the same as the temperature at the second end of the flexible tubing/hosing 5. Insulation materials include those that are typically used to insulate houses such as fiberglass, vacuum insulated materials, silica aerogels, polyurethane, polyisocyanurates, urea containing insulating materials, phenolic containing insulating materials, polystyrene containing insulating materials, various fabrics such as wool or cotton containing insulating materials, cellulose containing insulating materials, vermiculite, perlite, or other insulating materials.

The connection system 1 may be made of any material that allows the connection shaft 3 to be inserted into air vents or connections at the passenger or child safety seats. For example, the connection shaft 3 may be made of plastic, metal, hard rubber or other materials that allow the connection shaft 3 to maintain its structurally integrity when the connection shaft 3 is inserted into the various air vents and/or connection holes. In variations of the present invention, the hard plastic may be one or more polymers selected from the group consisting of a phenol/formaldehyde polymer, a polyvinylchloride polymer, a polycarbonate polymer, a butadiene styrene copolymer, a polycarbonate butadiene styrene copolymer, a polyetherether ketone polymer, a polyarylether ketone polymer, a clay nanosheet-containing water soluble polymer and/or mixtures thereof. In one embodiment, the mass of the connection system 1 is sufficiently light (and the tubing flexible enough) so that it can be easily moved and manipulated to allow its insertion into the air vents and/or passenger and/or child safety seats.

FIG. 2 shows another embodiment of the present invention wherein the screw connection system 20 contains a means of attaching the screw connection system 20 by a screw shaft 21 to the air vent of a vehicle and/or to a passenger and/or child safety seat. Air passes by way of screw shaft passageway 22 through flexible tubing/hosing 5 to the area where cooling/heating is desired (e.g., the child safety seat). It should be noted that although the screw shaft 21 is connected to the flexible tubing/hosing 5, in an embodiment, the screw shaft 21 may be turned/rotated independently of the flexible tubing/hosing 5 (similar to a garden hose wherein the attachment screw end can be rotated independently of the garden hose). In this embodiment, this allows the screw shaft 21 to be screwed into an air vent and/or passenger and/or child safety seat without consequently having the flexible tubing/hosing 5 rotating.

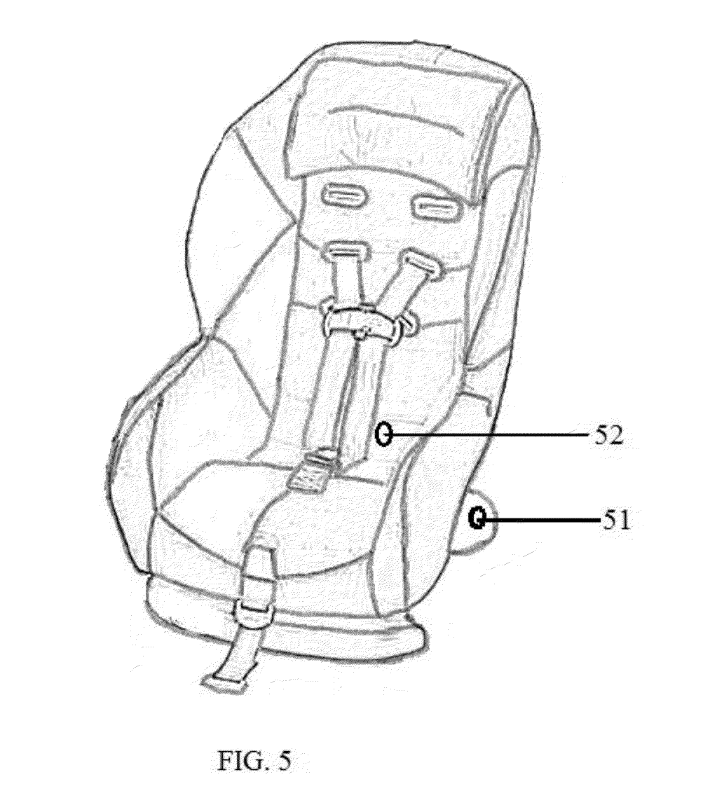

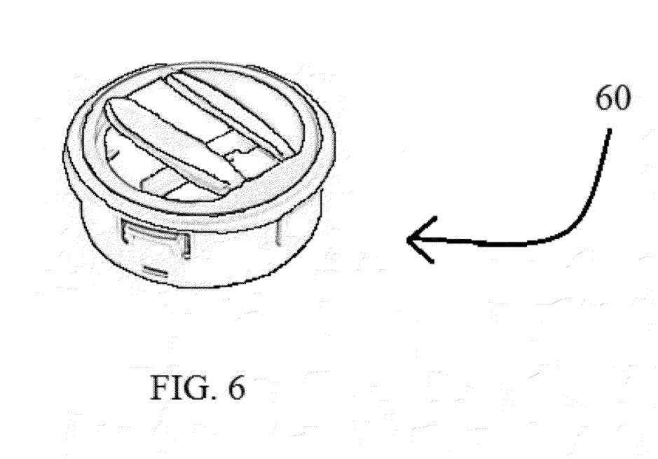

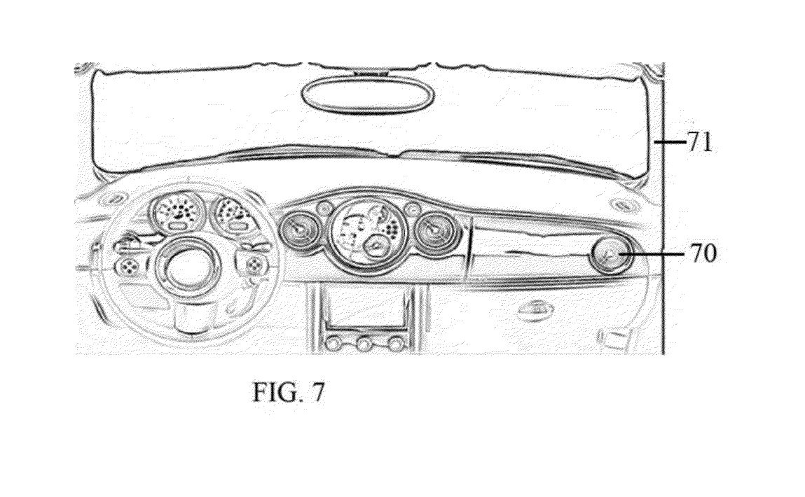

In an embodiment, the screw shaft 21 is made out of plastic, hard rubber, or metal. The male screw shaft 21 is designed to fit in a female screw reception hole that may be an air vent or a connection hole on a passenger seat and/or a child safety seat. FIG. 7 shows an air vent 70 that may he adapted to accommodate the screw shaft 21. By removing the vents from the air vent (see the vents 60 in FIG. 6), the air vent 70 no longer has the vents 60 impeding one's ability to connect the screw shaft 21 to the air vent 70. The air vent 70 may have screw threads (not shown in FIG. 7) that are designed to accommodate the threads of the screw shaft 21 so as to secure a tight fit so that the air can pass from the vent through screw shaft passageway 22 through flexible tubing/hosing 5 to the passenger or child safety seat. As shown in FIG. 5, child safety seat 50 may have an air entrance point 51 on the side of child safety seat 50 that is designed to accommodate a screw shaft 21. That is the threads, pitch and length of the female entrance point are designed to exactly accommodate the screw shaft 21. It should be understood that although air entrance point 51 on the child safety seat is shown as being round, any shape that can accommodate the far end of the flexible tubing/hosing may be used. For example, the air entrance point 51 may be a shape that is designed to accommodate the connection shaft 3 as shown in FIG. 1 (in this instance, the shape would be essentially rectangular). Other shapes and means of connecting the tubing/hosing 5 to both the air vent 70 and the air entrance point 51 are contemplated and within the scope of the invention.

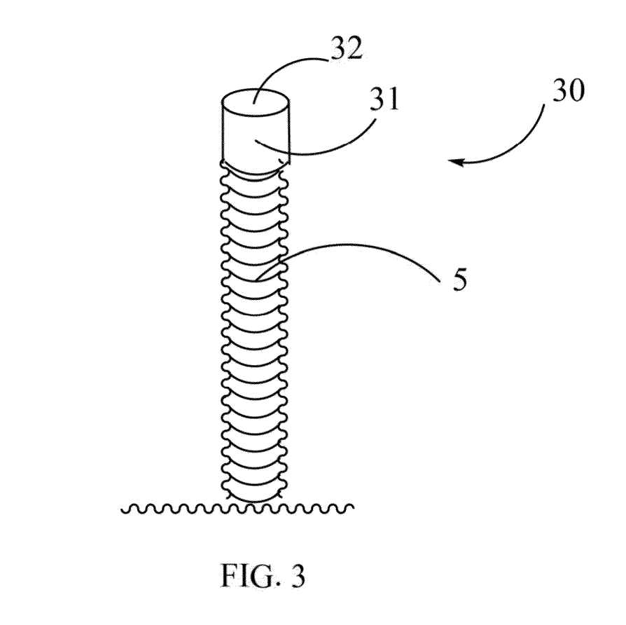

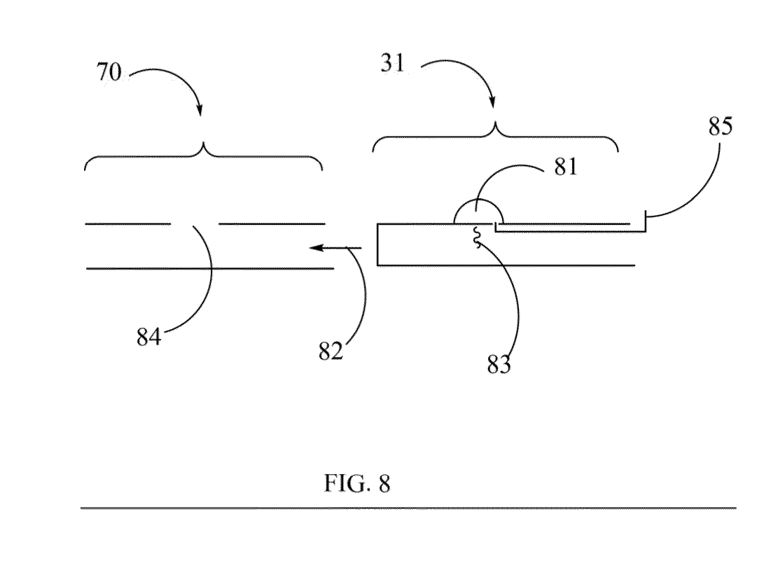

FIG. 3 shows another embodiment that allows cylindrical connection system 30 to be connected to air vent 70 and/or to air entrance point 51 on the side of child safety seat 50 wherein hard cylindrical end 31 can be inserted into either one of the air vent 70 and/or air entrance point 51 on child safety seat 50. The air passes through air passageway 32 allowing the child safety seat 30 (or alternatively a different passenger seat) to cool or warm as needed. It should be noted that hard cylindrical end 31 in an embodiment should fit snuggly into air vent 70 and/or to air entrance point 51 so that the air conditioned or heated air is delivered to the desired location. Air vent 70 may contain a means for holding hard cylindrical end 31 in place so that it cannot be easily removed. Although not shown in FIG. 3 but rather shown in FIG. 8 (and not necessarily drawn to scale), it is contemplated that hard cylindrical end 31 may contain a protrusion 81 that is connected with a means of depressing the protrusion 81 such as a spring 83. When cylindrical end 31 is inserted via direction 82 into air vent 70, the protrusion 81 is depressed using spring 83. When the protrusion reaches hole/slot 84 in air vent 70, the protrusion 81 pops out (similar to a snap fit) holding cylindrical end 31 in place. In an embodiment, there may be a lever 85 that is accessible (e.g., it is not positioned inside of air vent 70) or some other means of depressing protrusion 81 when cylindrical end 31 is securely in air vent 70. When lever 85 is depressed by a user, protrusion 81 is again depressed allowing a user to remove cylindrical end 31.

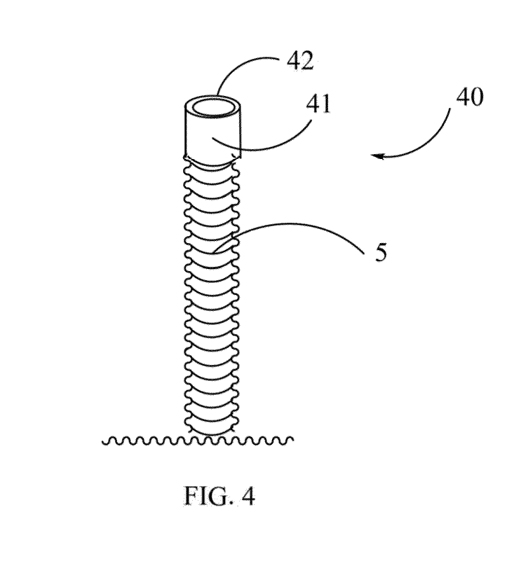

FIG. 4 shows another embodiment of the present invention comprising a magnetic system 40. In this embodiment, magnetic cylindrical end 41 is polarized such that the magnetic cylindrical end contains a magnetic tip 42 that when the magnetic cylindrical end 41 is inserted into air vent 70, the magnetic tip 42 contacts a point in the air vent 70 that relies on magnetic attraction to keep magnetic cylindrical end 41 in place. The magnetic attraction should be strong enough so that the magnetic cylindrical end 41 easily stays in place but can be easily removed without too much effort by a user.

In an embodiment, when air (either heated or cooled) goes from the air vent to the child safety seat (and/or to a passenger seat), the seat may have a thermal liquid or gas) phase change material contained in it that allows the seat to be cooled and/or heated. For example, U.S. Pat. No. 7,320,357 contains a phase change material that may be incorporated into the various seats. U.S. Pat. No. 7,320,357 is incorporated by reference herein in its entirety. It is contemplated that the various alkyl hydrocarbons may be incorporated into a foam and/or mesh material that provides cooling to one or more passengers in the vehicle. In an embodiment, a percentage of the air from the air vent may be directed to the thermal liquid (or gas) phase change material to cool the seat and a percentage of the air may be released to cool the air around the one or more passengers. This embodiment not only allows the seat to aid in cooling the passenger but also allows the adjacent ambient air to also cool the one or more passengers.

In an embodiment, the flexible tubing/hosing 5 may contain an air filter in it that filters air from the air vent to the one or more passengers. in one embodiment, the air filter is positioned inside the flexible tubing/hosing 5 close to the passenger seat so that particles that may be in the flexible tubing/hosing 5 are filtered prior to arriving to the one or more passengers' vicinity.

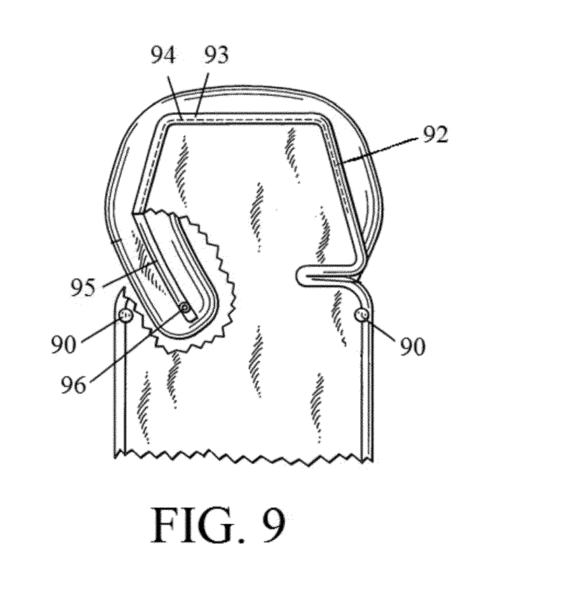

FIG. 9 shows an embodiment of the child seat is slightly more detail. Note that the flexible tubing can be connected at connection point 90. In an embodiment, connection point 90 may be on either side of the child seat to facilitate the position in the vehicle where the child seat is placed. If the flexible tubing is connected to connection point 90 that is on the right hand side of FIG. 9, the air passes through a tube that goes in a direction from connection point 90 to tube point 92 to tube point 93 to tube point 95. There may be slits 94 in the tube that allows the passage of air from the to the head of the infant. There may be a sensor at a point 96 that measures temperature, air flow, or other relevant data. This sensor may be able to communicate with a computer (or alternatively, with a smart phone) that allows a driver or another passenger to ascertain the comfort level of the infant.

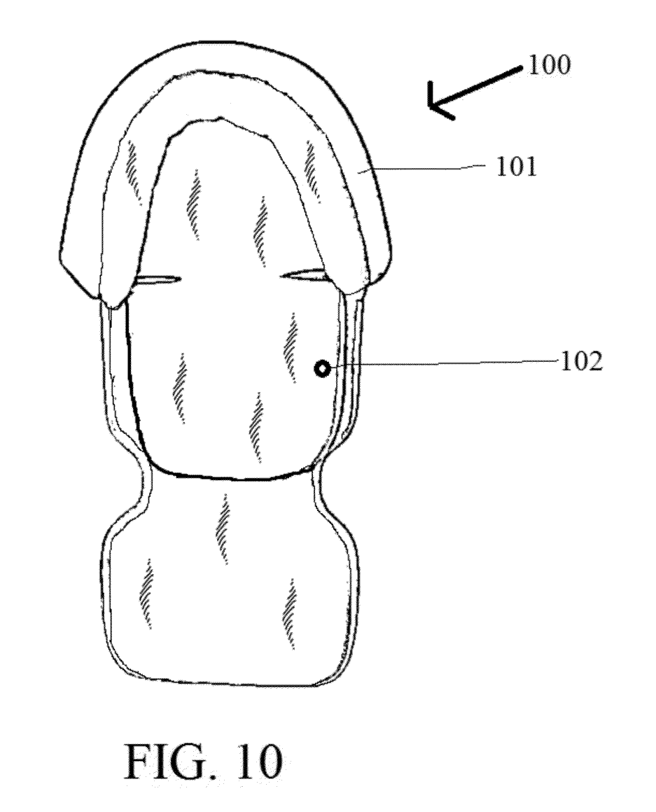

FIG. 10 shows a pad 100. The pad 100 is more readily moved than the child seat of FIG. 9. Similar to the child seat as shown in FIG. 9, the pad 100 has connection point 102 where the flexible tubing can be connected. Also, the pad may have the ability to allow the passage of air through head rest 101, which will keep the infant cool or warm. In a variation, the head rest 101 may comprise the phase change material discussed herein. Thus, when air passes from connection point 102 to head rest 101, the comfort level of the infant may be optimally maintained.

In an embodiment the vehicle that uses the systems and methods of the present invention may have devices that allow the flexible tubing/hosing 5 to remain substantially hidden while in use. For example, when it is desired that passengers in the back of the vehicle enjoy the use of the systems/methods of the present invention, the flexible tubing hosing 5 may pass under the front passenger seats to seat locations in the back. Alternatively, the flexible tubing/hosing 5 may pass along the ceiling of the interior of the vehicle to reach those locations. In an embodiment, there may be several sections of flexible tubing/hosing 5 and several sections where air passage play move through more permanent conduits. For example, a cylindrical end (for example, the magnetic cylindrical end 41) may be inserted into air vent 70 and a short section of flexible tubing/hosing 5 allows air to pass to a first end of as permanent conduit 71 alongside the windshield of a vehicle. The air passes from this proximal first end of a permanent conduit 71 to another conduit in the interior ceiling of the car (not shown) in a direction that allows air to flow to the back seat area. There may be additional conduits in the back seat area that allow the passage of air to a location close to one or more passenger seats. Another section of flexible tubing hosing 5 may allow the air to be connected, for example, from the second distal end of these permanent conduits to the air entrance point 51 on the side of child safety seat 50 thereby providing a child with the desired cooling or heating.

In an embodiment, the present invention relates to a system for cooling one or more passengers in a vehicle, said system comprising a conduit with a first end and a second end, the first end of the conduit designed to connect more air vents in the vehicle and the second end of the conduit designed to connect to one or more passenger seats in the vehicle.

In a variation, the conduit comprises a first hard connecter at the first end designed to connect to the air vent, said first plastic connecter also being connected to flexible tubing that has a proximal end and a distal end, wherein the flexible tubing allows passage of air in a direction from the proximal end of the flexible tubing to the distal end of the flexible tubing, the distal end of the flexible tubing being connected a second hard connecter, said second hard connecter being designed to connect to said one or more passenger seats in the vehicle.

In an embodiment, the first hard connecter and the second hard connecter are one or more of a hard plastic, a hard rubber or metal. In one variation, the first hard connecter and second hard connecter are both hard plastics. In a variation, only one of the first hard connecter and second hard connecter are hard plastics. in a variation, neither of the first hard connecter at second hard connecter are hard plastics.

In an embodiment, the hard plastics are one or more polymers selected from the group consisting of a phenol/formaldehyde polymer, a polyvinylchloride polymer, a polycarbonate polymer, a butadiene styrene copolymer, a polycarbonate butadiene styrene copolymer, a polyetherether ketone polymer, a polyarylether ketone polymer, and a clay nanosheet-containing water soluble polymer and/or mixtures thereof. In an embodiment, the hard rubbers are either natural or synthetic. In an embodiment, the metals are metals that have good structural integrity but are light. For example, the metals may be aluminum or tin, or alloys that contain aluminum or tin, or alternatively, may be steel.

In an embodiment, the system may have at least one of the first hard connecter or the second hard connecter in a shape that is cylindrical. Alternatively, the shape of the first hard connector or second hard connector may be square, triangular, rectangular, in the shape of a parallelogram, a rhombus, or another shape that allows the connecters to be connected to the air vent and/or passenger seat. In a variation, the first hard connecter and the second hard connector are not cylindrical in shape.

In an embodiment, the system may further comprise a mesh or foam material containing a phase change material. In a variation, the phase change material may comprise alkyl hydrocarbons. In an embodiment, the phase change material associated with the mesh or foam is selected so that the material undergoes a phase change at a temperature ideally suited to provide cooling or warming to one or more passengers.

In an embodiment, the first hard connecter or second hard connector are connected by mechanical means or magnetic means. In a variation, the first hard connecter or second hard connector comprises a protrusion designed to fit in a slot in an air vent and the protrusion snap fits the first hard connector or second hard connecter into place.

In an embodiment, the system may further comprise at least a second flexible tubing part/segment.

In an embodiment, the system may further comprise one or more permanent conduits, wherein the passage of air flows through these one or more permanent conduits. In a variation, the system contains one permanent conduit. In an embodiment, the permanent conduit may be in the interior ceiling of the vehicle or along the floor of the vehicle. In an embodiment the permanent conduit may go below the front vehicle seats.

In an embodiment, the system may contain a first hard connector or a second hard connecter that is connected by mechanical means and the mechanical means may comprise screw threads. In an embodiment, the mechanical means may be by snap fit. In an embodiment, the first hard connector or the second hard connecter may be connected by magnetic means. Alternatively, other fastening means are contemplated such means that utilize hook and loop (VELCRO) or other permanent or non-permanent adhesive means, screw hardware, nuts and bolts, or clips.

In an embodiment, the present invention relates to a method of cooling or warming one or more passengers in a vehicle, said method comprising facilitating air flow from one or more air vents in a vehicle via a conduit with a first end and a second end, the first end of the conduit designed to connect to one or more air vents in the vehicle and the second end of the conduit designed to connect to one or more passenger seats in the vehicle, wherein said conduit further comprises flexible tubing that allows air flow from the one or more air vents to the one or more passengers.

In an embodiment, the method may further comprise a mesh or foam material that comprises a phase change material, wherein the phase change material undergoes a phase change at a temperature that provides cooling or warming to the passenger. In a variation, the phase change material comprises one or more alkyl hydrocarbons.

In an embodiment, the method may use a first hard connecter or second hard connector that may be connected by mechanical means or magnetic means. In one variation, the first hard connecter or second hard connector is connected by mechanical means and the mechanical means comprises a snap fit or screw threads.

In an embodiment, the method may use a system that has at least two flexible tubing segments, a first flexible tubing segment that connects the first hard connecter to a proximal end of a permanent conduit adjacent to a windshield and a second flexible tubing segment that connects a distal end of the permanent conduit to a second hard connecter. In a variation, the second hard connecter attaches to an air entrance point on a child safety seat.

It should be understood that it is contemplated and therefore within the scope of the present invention that any embodiment described above and features enumerated therewith can be combined with any other embodiment and the features discussed with that embodiment. For example, the features that are disclosed as methods may be interchanged with any or all of the features that are disclosed as parts of systems. It is contemplated and therefore within the scope of the invention to include reasonable modifications to the embodiments described above without departing from the spirit and scope of the invention. In any event, the present invention is to be described by the below claims.

I claim:

1. A system for cooling, one or more passengers in a vehicle, said system comprising a conduit with a first end and a second end, the first end of the conduit designed to connect to one or more air vents in the vehicle and the second end of the conduit designed to connect to one or more passenger seats in the vehicle.

2. The system of claim 1, wherein the conduit comprises a first hard connecter at the first end designed to connect to the air vent, said first plastic connecter also being connected to flexible tubing that has a proximal end and a distal end, wherein the flexible tubing allows passage of air in a direction from the proximal end of the flexible tubing to the distal end of the flexible tubing, the distal end of the flexible tubing being connected a second hard connecter, said second hard connecter being designed to connect to said one or more passenger seats in the vehicle.

3. The system of claim 2, wherein the first hard connecter and the second hard connecter are one or more of a hard plastic, a hard rubber or metal.

4. The system of claim 3, wherein the first hard connecter and second hard connecter are both hard plastics.

5. The system of claim 4, wherein the hard plastics are one or more polymers selected from the group consisting of a phenol/formaldehyde polymer, a polyvinylchloride polymer, a polycarbonate polymer, a butadiene styrene copolymer, a polycarbonate butadiene styrene copolymer, a polyetherether ketone polymer, a polyarylether ketone polymer, and a clay nanosheet-containing water soluble polymer and/or mixtures thereof.

6. The system of claim 2, wherein at least one of the first hard connecter and the second hard connecter are cylindrical in shape.

7. The system of claim 1, further comprising a mesh in foam material containing a phase change material.

8. The system of claim 2, wherein the first hard connecter or second hard connector are connected by mechanical means or magnetic means.

9. The system of claim 8, wherein the first hard connecter or second hard connector comprises a protrusion designed to fit in a slot in an air vent.

10. The system of claim 2, further comprising at least a second flexible tubing part.

11. The system of claim 2, wherein the passage of air flows through at least one permanent conduit.

12. The system of claim 8, wherein at least one of the first hard connecter and the second hard connector are not cylindrical in shape.

13. The system of claim 8, wherein the mechanical means comprises screw threads.

14. A method of cooling or warming one or more passengers in a vehicle, said method comprising facilitating air flow from one or more air vents in a vehicle via a conduit with a first end and a second end, the first end of the conduit designed to connect to one or more air vents in the vehicle and the second end of the conduit designed to connect to one or more passenger seats in the vehicle, wherein said conduit further comprises flexible tubing that allows air flow from the one or more air vents to the one or more passengers.

15. The method of claim 14, further comprising a mesh or foam material that comprises a phase change material, wherein the phase change material undergoes a phase change at a temperature that provides cooling or warming to the passenger.

16. The method of claim 15, wherein the phase change material comprises one or more alkyl hydrocarbons.

17. The method of claim 14, wherein the first hard connecter or second hard connector are connected by mechanical means or magnetic means.

18. The method of claim 17, wherein the first hard connecter or second hard connector are connected by mechanical means and the mechanical means comprises a snap fit or screw threads.

19. The method of claim 14, comprising at least two flexible tubing segments, a first flexible tubing segment that connects the first hard connecter to a proximal end of a permanent conduit adjacent to a windshield and a second flexible tubing segment that connects a distal end of the permanent conduit to a second hard connecter.

20. The method of claim 19, wherein the second hard connecter attaches to an air entrance point on a child safety seat.
